(19) United States
(12) Patent Application Publication
(10) Pub. No.: US 2021/0081406 A1
(43) Pub. Date: Mar. 18, 2021

(54) BLOCKCHAIN NETWORK

(71) Applicant: MORROWBOGI, Seoul (KR)

(72) Inventors: Daehyun KWON, Seongnam-si (KR); Gwangho SHIN, Seoul (KR); Myoung Seok SONG, Seoul (KR)

(21) Appl. No.: 17/022,288

(22) Filed: Sep. 16, 2020

(30) Foreign Application Priority Data
Sep. 16, 2019 (KR) 10-2019-0113427

(51) Int. Cl. G06F 16/23; G06F 9/54; G06F 16/22; G06Q 20/36; G06Q 20/40; G06Q 30/00; G06Q 10/10; G06Q 40/04; G06Q 20/06

(52) U.S. Cl. CPC G06F 16/2379; G06F 9/547; G06F 16/2255; G06Q 20/3674; G06Q 20/40; G06Q 2220/00; G06Q 10/10; G06Q 40/04; G06Q 20/0655; G06F 16/2365; G06Q 30/0185

(57) ABSTRACT

Present invention is related to blockchain networks, which may include: a legacy system including service delivery server and a plurality of user terminals connected to the service delivery server for receiving a service; a middleware system including a plurality of middleware nodes validates the service delivery server and the original transaction data received from the service provider server, and generates a unit transaction, and internally notarizes the validity of the original transaction data included in the unit transaction, and transmits an approval signal, and generates the current cell block including the approved unit transactions, and internally confirms the current cell block for the current cell block and adds the end of the chain of cells in which the blocks of multiple cells are connected; and a main net including a plurality of main net nodes stores the unit transactions received from the middleware system.

### CROSS-REFERENCE TO RELATED APPLICATIONS

This application claims priority to Korean Patent Application No. 10-2019-0113427 filed on Sep. 16, 2019 in the Korean Intellectual Property Office (KIPO), the entire contents of which are hereby incorporated by reference.

### TECHNICAL FIELD

The present invention relates to a block chain technology, and more particularly, to a block chain network that connects the existing legacy system and the block chain main net using a middleware system.

### BACKGROUND ART

Blockchain represents a digital ledger in which transaction details occurring between users are shared and stored among network members.

Transaction details that occur between users for a certain period of time are confirmed through consensus of more than half of the users, and the confirmed transaction details are grouped into one block and stored in the blockchain.

In order to modify the transaction details included in the block connected to the blockchain, the consensus of more than half of users must be obtained again for the block and all blocks connected after the block.

Data stored in the blockchain is virtually impossible to forge or after.

Since it is impossible to arbitrarily change the transaction details stored in the blockchain, the reliability of the data stored in the blockchain is very high.

Therefore, in recent years, researches to safely store transaction details using a block chain are being actively conducted in industrial fields dealing with transactions between users, such as Internet commerce and financial services.

However, there is a problem in that many modifications to the existing system are required in order to integrate the blockchain system with the existing system.

In addition, in order to store new transaction details in the blockchain, a new block must be created through a process called mining, so it takes a lot of time to store transaction details occurring in the existing system in the blockchain.

Therefore, if the transaction details generated in the existing system are stored in the blockchain, there is a problem that a lot of waiting time is required to confirm the transaction details that have occurred.

### INVENTION DISCLOSURE

### Technical Problem

One object of the present invention for solving the above problems is to provide a blockchain network having a configuration in which an existing legacy system is connected to the blockchain main net through a middleware system.

### Technical Solution

In order to achieve the object of the present invention described above, a blockchain network according to an embodiment of the present invention may include a legacy system, a middleware system, and a main net.

The legacy system may include a service providing server and a plurality of user terminals connected through a wired or a wireless network to the service providing server to receive a service.

The middleware system may include a plurality of middleware nodes connected to each other through a network, and verify the validity of the original transaction data by performing a first agreement algorithm with the service providing server on the original transaction data received from the service providing server, if the verification is successful, a unit transaction including the original transaction data is generated, and a second consensus algorithm is internally performed on the unit transaction to notarize the validity of the original transaction data included in the unit transaction, if the notarization is successful, approve the unit transaction, transmit an approval signal indicating that the original transaction data has been approved to the service providing server, and create the current cell block that includes the unit transactions approved through the second consensus algorithm for a reference time, the current cell block is determined by internally performing a third consensus algorithm on the current cell block, and the determined current cell block is added to the end of the cell block chain to which a plurality of cell blocks are connected.

The main net may include a plurality of main net nodes and store the unit transaction received from the middleware system in a main blockchain shared between the plurality of main net nodes.

Main net: Main Bitcoin network and its blockchain. The term is mostly used in comparison to test net.

### Effects of the Invention

The blockchain network according to the embodiments of the present invention can safely store original transaction data generated from the legacy system in the blockchain of the main net without major changes to the existing legacy system.

In addition, the blockchain network according to the embodiments of the present invention can approve the conclusion of a contract corresponding to the original transaction data before the original transaction data generated from the legacy system is stored in the blockchain of the main net.

The original transaction data generated from the legacy system can be safely stored in the main net's main blockchain without slowing down the transaction contract execution speed of the legacy system.

### BRIEF DESCRIPTION OF DRAWINGS

FIG. 1 is a diagram illustrating a blockchain network according to an embodiment of the present invention.

FIG. 2 is a diagram illustrating an example of original transaction data transmitted from a service providing server to a middleware system in the block chain network of FIG. 1.

FIG. 3 is a diagram illustrating a process of performing a first consensus algorithm performed in the block chain network of FIG. 1.

FIG. 4 is a diagram illustrating a process of performing a second consensus algorithm performed in the block chain network of FIG. 1.

FIG. 5 is a diagram illustrating an example of a current Merkle tree that is periodically generated at each reference time in the block chain network of FIG. 1.

FIG. 6 is a diagram illustrating an example of a current cell block periodically generated at each reference time in the block chain network of FIG. 1.

FIG. 7 is a diagram illustrating a process of performing a third consensus algorithm performed in the block chain network of FIG. 1.

FIG. 8 is a diagram illustrating an example of a cell block chain to which a current cell block has been added.

### DETAILED DESCRIPTION

In the following detailed description, numerous specific details may be set forth in order to provide a thorough understanding of embodiments of the invention. However, it will be clear to one skilled in the art when embodiments of the invention may be practiced without some or all of these specific details. In other instances, well-known features or processes may not be described in detail so as not to unnecessarily obscure the invention. In addition, like or identical reference numerals may be used to identify common or similar elements. Moreover, unless otherwise defined, all technical and scientific terms used herein have the same meaning as commonly understood by one of ordinary skill in the art to which this invention belongs. In case of conflict, the present specification, including the definitions herein, will control.

Although other methods and can be used in the practice or testing of the invention, certain suitable methods and materials are described herein.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

Moreover, where a range of numerical values is recited herein, comprising upper and lower values, unless otherwise stated in specific circumstances, the range is intended to include the endpoints thereof, and all integers and fractions within the range. It is not intended that the scope of the invention be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an endpoint of a range, the disclosure should be understood to include the specific value or endpoint referred to.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; more specifically, the phrase “A or B” means “A, B, or both A and B”. Exclusive “or” is designated herein by terms such as “either A or B” and “one of A or B”, for example.

The indefinite articles “a” and “an” are employed to describe elements and components of the invention. The use of these articles means that one or at least one of these elements or components is present. Although these articles are conventionally employed to signify that the modified noun is a singular noun, as used herein the articles “a” and “an” also include the plural, unless otherwise stated in specific instances. Similarly, the definite article “the”, as used herein, also signifies that the modified noun may be singular or plural, again unless otherwise stated in specific instances.

For the purposes of describing the embodiments, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the claimed invention it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

It is noted that one or more of the claims may utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

It is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

In addition, aspect of the present disclosure may include software or machine-executable commands (for example, operating systems, applications, firmware, programs, etc.) causing methods of various embodiments to be executed on a device or a computer, and a non-transitory computer-readable medium in which such software or machine-executable commands are stored so as to be executable on a device or a computer.

Hereinafter, preferred embodiments of the present invention will be described in more detail with reference to the accompanying drawings. The same reference numerals are used for the same elements in the drawings, and duplicate descriptions for the same elements are omitted.

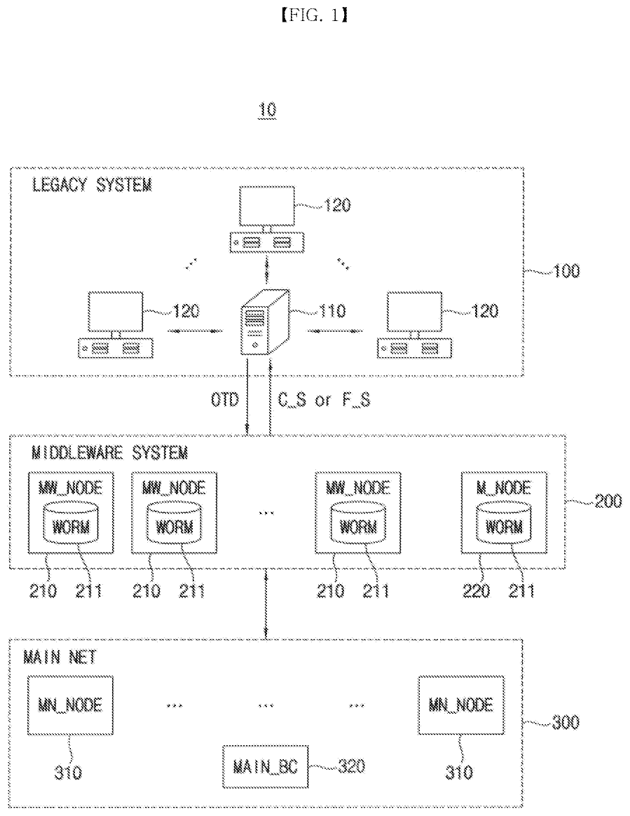

FIG. 1 is a diagram illustrating a blockchain network according to an embodiment of the present invention.

Referring to FIG. 1, the blockchain network 10 may include a legacy system 100, a middleware system 200, and a main net 300.

The legacy system 100 may include a service providing server 110 and a plurality of user terminals 120.

The service providing server 110 and the plurality of user terminals 120 may be connected to each other through a wired and/or a wireless network.

The service providing server 110 may provide various types of services, and the plurality of user terminals 120 may access the service providing server 110 to use the services provided by the service providing server 110.

The service providing server 110 may provide a service dealing with a transaction between users or a transaction between a service provider and a user according to an embodiment of the present invention.

For example, the service provided by the service providing server 110 may be an Internet commerce service or a financial service. However, it is not limited thereto.

The service providing server 110 may transmit original transaction data (OTD) representing a transaction between a plurality of user terminals 120 or a transaction between the plurality of user terminals 120 and the service providing server 110 to the middleware system 200.

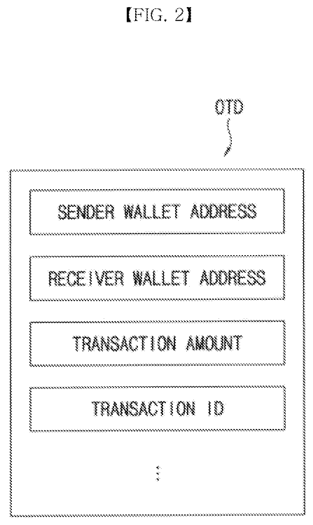

FIG. 2 is a diagram illustrating an example of original transaction data transmitted from a service providing server to a middleware system in the block chain network of FIG. 1.

Referring to FIG. 2, the original transaction data (OTD) may include a sender wallet address, a receiver wallet address, a transaction amount, and a transaction ID.

In this case, the original transaction data (OTD) may represent a transaction contract for transferring the transaction amount from a wallet corresponding to the sender wallet address to a wallet corresponding to the receiver wallet address.

The original transaction data (OTD) shown in FIG. 2 is an exemplary embodiment, and the present invention is not limited thereto, according to embodiments, the original transaction data (OTD) may further include various types of information about the transaction.

For example, the original transaction data (OTD) may further include an ID of a store in which the transaction is made, a fee according to the transaction, and the like.

Referring back to FIG. 1, after the service providing server 110 transmits the original transaction data (OTD) to the middleware system 200, the service providing server 110 may wait until receiving one of a failure signals (F_S) or an approval signal (C_S) for the original transaction data (OTD) from the middleware system 200.

If the service providing server 110 receives the approval signal (C_S) for the original transaction data (OTD) from the middleware system 200, the service providing server 110 determines that the conclusion of a transaction contract corresponding to the original transaction data (OTD) has been approved, and proceed a next transaction contract based on the transaction contract.

On the other hand, if the service providing server 110 receives the failure signal F_S for the original transaction data (OTD) from the middleware system 200, the service providing server 110 may determine that the transaction contract corresponding to the original transaction data (OTD) has been disapproved.

The service providing server 110 may include an open API for performing data communication with the middleware system 200 according to an embodiment of the present invention.

In this case, using the open API, the service providing server 110 may transmit an original transaction data (OTD) representing a transaction between a plurality of user terminals 120 or a transaction between the plurality of user terminals 120 and the service providing server 110 to the middleware system 200. In addition, the service providing server 110 may receive an approval signal (C_S) and/or a failure signal F_S from the middleware system 200.

Meanwhile, the middleware system 200 may perform a first consensus algorithm with the service providing server 110 on the original transaction data (OTD) received from the service providing server 110 to verify the validity of the original transaction data (OTD).

If the verification fails, the middleware system 200 may transmit a failure signal F_S indicating that the original transaction data ODT has been disapproved to the service providing server 110.

On the other hand, if the verification is successful, the middleware system 200 may generate a unit transaction including the original transaction data (OTD) and notarize a validity of the original transaction data included in the unit transaction by internally performing a second consensus algorithm on the unit transaction.

If the notarization fails, the middleware system 200 may discard the unit transaction and transmit a failure signal F_S indicating that the original transaction data ODT has been disapproved to the service providing server 110.

On the other hand, if the notarization is successful, the middleware system 200 may approve the unit transaction and transmit an approval signal (C_S) indicating that the original transaction data (OTD) has been approved to the service providing server 110.

Meanwhile, the middleware system 200 may generate a current cell block including the unit transactions approved through the second consensus algorithm for a reference time, and internally perform a third consensus algorithm on the current cell block.

If consensus on the current cell block is successful through the third consensus algorithm, the middleware system 200 may determine a current cell block and add the determined current cell block to an end of a cell block chain in which a plurality of cell blocks are connected in a chain form.

On the contrary, if consensus on the current cell block fails through the third consensus algorithm, the middleware system 200 may discard the current cell block.

Meanwhile, the middleware system 200 may periodically or aperiodically transmit the unit transactions included in the cell blocks connected to the cell block chain to the main net 300.

The main net 300 may include a plurality of main net nodes (MN_NODE) 310 connected to each other through a Peer to Peer (P2P) network.

The main net 300 may include a main blockchain (MAIN_BC) 320 shared between a plurality of main net nodes 310.

The main block chain 320 may correspond to a digital ledger that stores the unit transactions received from the middleware system 200.

A plurality of main net nodes 310 generate a block including the unit transactions received from the middleware system 200 for a predetermined time, after consensus between the plurality of main net nodes 310 on the generated block, if the consensus is successful, the unit transactions can be safely stored in the main blockchain 320 by adding the generated block to the main blockchain 320.

The main net 300 may correspond to a public main net through which any node can participate as the main net node 310 according to an embodiment of the present invention.

In another embodiment, the main net 300 may correspond to a private main net in which only authorized nodes can participate as the main net node 310.

For example, the main net 300 may be privately operated by an operator of the service providing server 110. In this case, the main net 300 may be used for securely storing the unit transactions generated from the service providing server 110 in the main blockchain 320.

The main net 300 may be implemented using a generally widely known blockchain platform such as Ethereum and Bitcoin. Therefore, a detailed description of the structure of the main blockchain 320 and the operation of the main net 300 storing the unit transactions in the main blockchain 320 will be omitted.

Meanwhile, in FIG. 1, as an example, the legacy system 100 is illustrated as including one service providing server 110.

However, the present invention is not limited thereto, and the legacy system 100 may include a plurality of service providing servers 110 according to embodiments of the present invention.

In this case, each of the plurality of service providing servers 110 may safely store the generated original transaction data (OTD) in the main blockchain 320 of the main net 300 through the middleware system 200.

As described above, the service providing server 110 included in the legacy system 100 may not include a blockchain-related module for performing direct data communication with the main net 300. However, the service providing server 110 may store an original transaction data (OTD) in the main blockchain 320 of the main net 300 through the middleware system 200 by using the open API for performing data communication with the middleware system 200.

Hereinafter, the configuration and operation of the block chain network 10 will be described in more detail with reference to FIGS. 1 to 8.

The middleware system 200 may include a plurality of middleware nodes (MW_NODE) 210 connected to each other through a network.

In one embodiment, the plurality of middleware nodes 210 may be connected to each other through a TCP/IP network.

The middleware system 200 may further include a master node (M_NODE) 220 that manages the plurality of middleware nodes 210.

The new node may participate as the middleware node 210 in the middleware system 200 with the permission of the master node 220.

In addition, the master node 220 may manage a list of the plurality of middleware nodes 210, monitor the operation state of the plurality of middleware nodes 210, and provide a list and a plurality of addresses of the middleware nodes 210 to the service providing server 110.

As described above, if a transaction contract is concluded between the plurality of user terminals 120 or the transaction contract is concluded between the plurality of user terminals 120 and the service providing server 110, the service providing server 110 may generate an original transaction data (OTD) representing the transaction contract.

If the service providing server 110 generates the original transaction data (OTD), first, the service providing server 110 may transmit the original transaction data (OTD) to a first middleware node selected from among a plurality of middleware nodes 210. Next, the service providing server 110 with the first middleware node may perform the first consensus to verify a validity of the original transaction data (OTD) in two steps.

In one embodiment, first, the service providing server 110 may randomly select and determine one of a plurality of middleware nodes based on a list of a plurality of middleware nodes 210 as the first middleware node provided from the master node 220 and addresses of the plurality of middleware nodes 210. Second, the service providing server may transmit the original transaction data (OTD) to the first middleware node, and may perform the first consensus algorithm to verify the validity of the original transaction data (OTD) together with the first middleware node 110.

In another embodiment, the first middleware node may be predetermined by the master node 220 among the plurality of middleware nodes 210.

In this case, the service providing server 110 may transmit the original transaction data (OTD) to the predetermined first middleware node among the plurality of middleware nodes 210. The service providing server 110 together with the first middleware node may perform the first consensus algorithm to verify the validity of the original transaction data (OTD) in two steps.

In an embodiment according to the present invention, each of the plurality of middleware nodes 210 and the master node 220 may include a write once read many (WORM) storage 211. Here, the WORM storage 211 denotes a data storage device in which, once data is written, only a read operation is possible for the written data, and the written data cannot be changed or deleted.

If each of the plurality of middleware nodes 210 receive the original transaction data (OTD) from the service providing server 110, the original transaction data (OTD) may be stored in the WORM storage 211.

In addition, the master node 220 may periodically back up the original transaction data (OTD) stored in the WORM storage 211 of each of the plurality of middleware nodes 210 and store them in the WORM storage 211 included therein.

Therefore, even if a hacking attack on the middleware system 200 occurs, the original transaction data (OTD) received from the service providing server 110 is safely stored in the WORM storage included in the plurality of middleware nodes 210 and/or the master node 220.

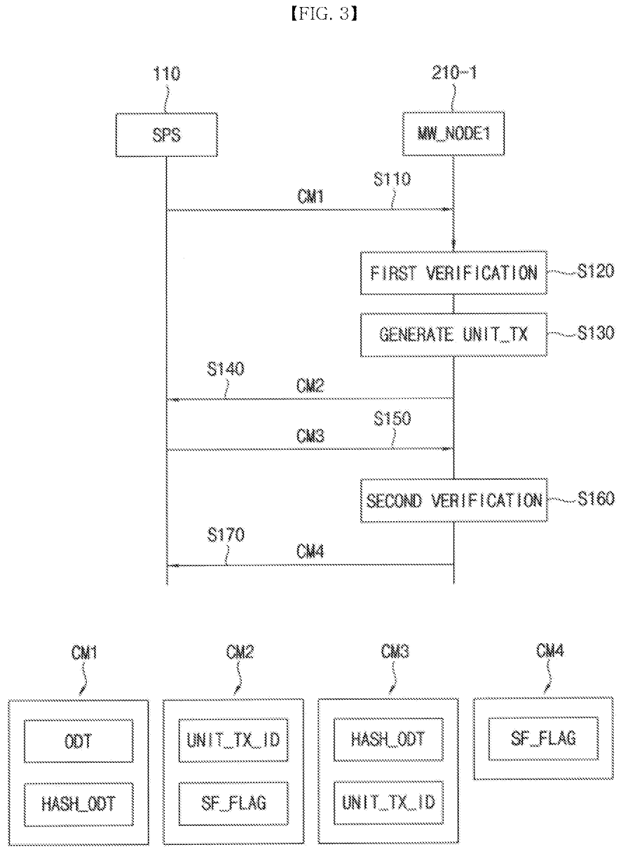

FIG. 3 is a diagram illustrating a process of performing a first consensus algorithm performed in the block chain network of FIG. 1.

FIG. 3 illustrates a detailed process of the first consensus algorithm performed between the service providing server (SPS) 110 and the first middleware node (MW_NODE1) 210-1.

Referring to FIG. 3, if the service providing server 110 and the first middleware node 210-1 perform the first consensus algorithm, the service providing server (SPS) 110 may create original transaction data (OTD), and calculate a hash value (HASH_ODT) for the original transaction data (OTD), transmit a first confirmation message (CM1) including a hash value (HASH_ODT) for the original transaction data (OTD) and the original transaction data (OTD)) to the first middleware node 210-1 (step S110).

If the first middleware node 210-1 receives the first confirmation message CM1 from the service providing server 110, the first middleware node 210-1 may store the original transaction data (OTD) included in the first confirmation message (CM1) in the internally included the WORM storage 211, and verify first a validity of the original transaction data (OTD) included in the confirmation message CM1 may be verified using the hash value (HASH_ODT) included in the first confirmation message (CM1) (step S120).

In one embodiment, the first middleware node 210-1 may calculate a hash value for the original transaction data ODT included in the first confirmation message CM1, if the calculated hash value and the hash value (HASH_ODT) included in the first confirmation message (CM1) match, it is determined that the first verification has been successful, and if the calculated hash value and the hash value (HASH_ODT) included in the first confirmation message (CM1) does not match, it may be determined that the first verification has failed.

If the first verification is successful, the first middleware node 210-1 may generate a unit transaction (UNIT_TX) including the original transaction data (OTD) and the hash value HASH_ODT (step S130).

Thereafter, the first middleware node 210-1 may transmit a unit transaction ID (UNIT_TX_ID) indicating the generated unit transaction (UNIT_TX) and a second confirmation message CM2 including a verification result flag (SF_FLAG) having a first value to the service providing server 110 (step S140).

On the other hand, if the first verification fails, without generating a unit transaction (UNIT_TX), the first middle ware node 210-1 may transmit the second confirmation message CM2 including the verification result flag (SF_FLAG) having the second value may correspond to a failure signal F_S indicating that the original transaction data (OTD) is disapproved to the service providing server 110 (step S140) and stop executing of the first consensus algorithm.

Therefore, if the service providing server 110 receives the second confirmation message (CM2) including the verification result flag (SF_FLAG) having the second value from the first middleware node 210-1, the service providing server 110 may determine that the transaction contract corresponding to the original transaction data (OTD) has been disapproved.

In contrast, if the service providing server 110 receives the second confirmation message (CM2) including the verification result flag (SF_FLAG) having the first value from the first middleware node 210-1, the service providing server 110 may transmit a third confirmation message CM3 including a hash value (HASH_ODT) and a unit transaction ID (UNIT_TX_ID) included in the second confirmation message (CM2) to the first middleware node 210-1 (Step S150).

The first middleware node 210-1 may secondary verify original transaction data (OTD) included in the unit transaction (UNIT T) corresponding to the unit transaction ID (UNIT_TX_ID) included in the third confirmation message (CM3) by using the hash value (HASH_ODT) included in the third confirmation message (CM3) (step S160).

The first middleware node 210-1 calculates a hash value for the original transaction data (OTD) included in the unit transaction (UNIT_TX) corresponding to the unit transaction ID (UNIT_TX_ID included in the third confirmation message (CM3). If the calculated hash value and the hash value (HASH_ODT) included in the third confirmation message (CM3) match, it may be determined that the second verification has been successful. On the other hand, if the calculated hash value and the hash value (HASH_ODT) included in the third confirmation message (CM3) do not match, it may be determined that the second verification has failed.

If the second verification fails, the first middleware node 210-1 may discard the unit transaction (UNIT_TX), and transmit a fourth confirmation message (CM4) including a verification result flag (SF_FLAG) having the second value to the service providing server 110 (step S170).

The fourth confirmation message (CM4) including the verification result flag SF_FLAG having the second value may correspond to a failure signal F_S indicating that the original transaction data (OTD) is disapproved.

Therefore, if the service providing server 110 receives the fourth confirmation message (CM4) including the verification result flag (SF_FLAG) having the second value from the first middleware node 210-1, the service providing server 110 may determine that the transaction contract corresponding to the original transaction data (OTD) has been disapproved.

On the other hand, if the second verification is successful, the first middleware node 210-1 may send a fourth confirmation message (CM4) including a verification result flag (SF_FLAG) having the first value to the service providing server 110 (step S170).

As described above, since the service providing server 110 and the first middleware node 210-1 verify the validity of the original transaction data (OTD) in two steps through the first consensus algorithm, the blockchain network 10 can have high reliability.

On the other hand, the first middleware node 210-1 may store the unit transaction (UNIT_TX) in the WORM storage 211 included therein after the second verification is successful, the second consensus algorithm may be performed for a unit transaction (UNIT_TX).

The second consensus algorithm may be performed between a notarized node selected from among a plurality of middleware nodes 210 and the first middleware node 210-1.

According to an embodiment of the present invention, the service delivery server 110 may select a notarization node to carry out the second consensus algorithm with the middleware node 210-1 among multiple middleware nodes 210 and notify to the first middleware node 210-1.

For example, the service providing server 110 may select the notarization node to perform the second consensus algorithm among a plurality of middleware nodes 210. And then, the service providing Server 110 may include information about the above notarization node in the first confirmation Message (CM1) and send the first confirmation message (CM1) to the first middleware Node 210-1 in the course of performing the above first consensus algorithm.

In another embodiment, the notarization node to perform the second consensus algorithm together with the first middleware node 210-1 may be selected from a plurality of middleware nodes 210 by the first middleware node 210-1.

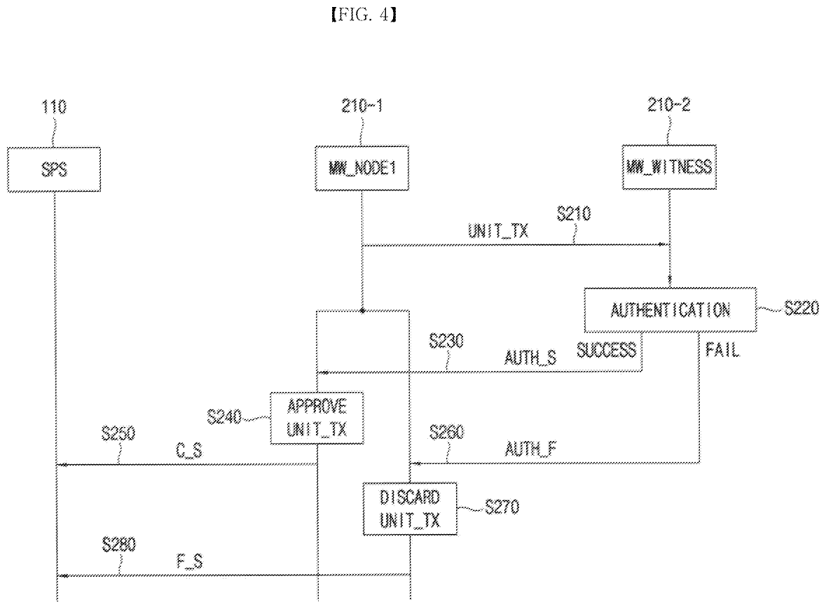

FIG. 4 is a diagram illustrating a process of performing a second consensus algorithm performed in the block chain network of FIG. 1

FIG. 4 shows a detailed process of the second consensus algorithm performed between the first middleware node (MW_NODE1) 210-1 and the notarization node (MW_WITNESS) 210-2.

Referring to FIG. 4, if a first middleware node 210-1 and a notarization node 210-2 perform the second consensus algorithm for a unit transaction (UNIT_TX), the first middleware node 210-1 may transmit a unit transaction (UNIT_TX) including the original transaction data (OTD) and a hash value (HASH_ODT) for the original transaction data (OTD) to the notarization node 210-2 (step S210).

If receiving the unit transaction (UNIT_TX) from the first middleware node 210-1, the notarization node 210-2 may notarize the validity of the original transaction data (ODT) included in the unit transaction (UNIT_TX) by using the hash value (HASH_ODT) included in the unit transaction (UNIT_TX) (step S220).

In one embodiment, the notary node 210-2 calculates a hash value for the original transaction data (OTD) included in the unit transaction (UNIT_TX), if the calculated hash value and the hash value (HASH_ODT) included in the unit transaction (UNIT_TX) match, it is determined that the notarization was successful. However, if the calculated hash value and the hash value (HASH_ODT) included in the unit transaction (UNIT_TX) do not match, it may be determined that the notarization has failed.

If the notarization is successful, the notarization node 210-2 may transmit a notarization success signal (AUTH_S) to the first middleware node 210-1 (step S230).

If the first middleware node 210-1 receives the notarization success signal (AUTH_S) from the notary node 210-2, the first middleware node 210-1 may approve the unit transaction (UNIT_TX) (step S240) and transmit an approval signal (C_S) to the service providing server 110 (step S250).

If the service providing server 110 receives the approval signal (C_S) from the first middleware node 210-1, the service providing server 110 may determine that the conclusion of the transaction contract corresponding to the original transaction data (OTD) has been approved, and proceed to a conclusion of the next transaction contract based on the transaction contract.

In addition, if the notarization is successful, the notarization node 210-2 may store the unit transaction (UNIT_TX) received from the first middleware node 210-1 in the WORM storage 211 included therein.

On the other hand, if the notarization fails, the notarization node 210-2 may transmit the notarization failure signal (AUTH_F) to the first middleware node 210-1 (step S260).

If the first middleware node 210-1 receives the notarization failure signal (AUTH_F) from the notarization node 210-2, the first middleware node 210-1 may discard the unit transaction (UNIT_TX) transmitted to the notary node 210-2 (step S270),

And then, the first middleware node 210-1 may transmit a failure signal (F_S) indicating that the original transaction data (OTD) has been disapproved to the service providing server 110 (step S280).

If the service providing server 110 receives the failure signal F_S from the first middleware node 210-1, the service providing server 110 may determines that the transaction contract corresponding to the original transaction data (OTD) has been disapproved.

As described above with reference to FIGS. 1 to 4, in the blockchain network 10 according to embodiments of the present invention, if the service providing server 110 generates the original transaction data (OTD), the service providing server 110 and the first middleware node 210-1 may verify the validity of the original transaction data (OTD) by performing the first consensus algorithm on the original transaction data (OTD).

If the verification is successful, the first middleware node 210-1 generates a unit transaction (UNIT_TX) including the original transaction data (OTD) and the hash value (HASH_ODT) for the original transaction data (OTD).

Thereafter, the first middleware node 210-1 and the notarization node 210-2 notarize the validity of the original transaction data (OTD) by performing the second consensus algorithm on the unit transaction (UNIT_TX), and if successful, the first middleware node 210-1 may approve the unit transaction (UNIT_TX).

Meanwhile, the first middleware node 210-1 may periodically generate a current cell block including unit transactions (UNIT_TX) approved through the second consensus algorithm during the reference time period at each reference time.

Specifically, the first middleware node 210-1 may create a Merkle tree using the hash values (HASH_ODTs) for unit transactions (UNIT_TX) and unit transactions (UNIT_TX) approved through the second consensus algorithm during the reference time.

The reference time may be a predetermined time, for example, the reference time may correspond to 1 minute according to an embodiment of the present invention.

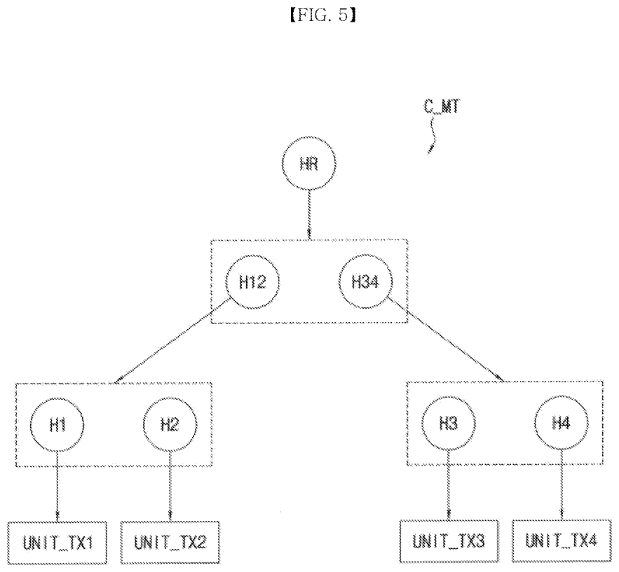

FIG. 5 is a diagram for explaining an example of a current Merkle tree that is periodically generated at every reference time in the block chain network of FIG. 1,

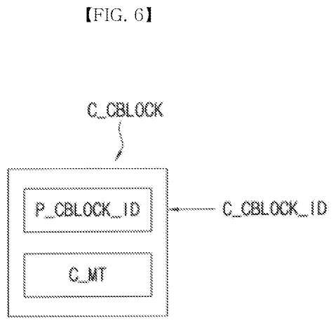

FIG. 6 is a diagram illustrating an example of a current cell block periodically generated at each reference time in the block chain network of FIG. 1.

In FIG. 5 shows that if a first unit transaction (UNIT_TX1), a second unit transaction (UNIT_TX2), a third unit transaction (UNIT_TX3), and a fourth unit transaction (UNIT_TX4) are approved during the reference time period through the second consensus algorithm. a current Merkle tree (C_MT) is generated using a first unit transaction (UNIT_TX1), a second unit transaction (UNIT_TX2), a third unit transaction (UNIT_TX3), and a fourth unit transaction (UNIT_TX4).

As shown in FIG. 5, the first middleware node 210-1 may calculate a hash value for each of a first unit transaction (UNIT_TX1), a second unit transaction (UNIT_TX2), and a third unit transaction (UNIT_TX3), and the fourth unit transaction (UNIT_TX4) approved through the second consensus algorithm during the reference time.

The first middleware node 210-1 may calculate a first hash value (H1) for a first unit transaction (UNIT_TX1), a second hash value (H2) for a second unit transaction (UNIT_TX2), a third unit transaction (UNIT_TX3), a fourth hash value (H4) for the fourth unit transaction (UNIT_TX4). After calculating the above hash values, the first middleware node 210-1 may calculate a fifth hash value H12 for a value obtained by merging the first hash value (H1) and the second hash value (H2), and a sixth hash value H34 for a value obtained by merging the third hash value (H3) and the fourth hash value (H4).

Thereafter, the first middleware node 210-1 calculates the seventh hash value HR for the merged value of the fifth hash value H12 and the sixth hash value H34, and create a current Merkle tree C_MT by connecting the first to fourth units Transactions (UNIT_TX1, UNIT_TX2, UNIT_TX3, UNIT_TX4) and first to seventh hash values (H1, H2, H3, H4, H12, H34, HR) in a tree structure as shown in FIG. 5.

Here, the seventh hash value HR may correspond to the root of the current Merkle tree (C_MT).

The first middleware node 210-1 periodically create the current Merkle Tree (C_MT) using hash values (HASH_ODTs) for unit transactions (UNIT_TX) and unit transactions (UNIT_TX) approved through the second consensus algorithm during the reference time period at each reference time. As shown in FIG. 6, after creating the Merkle Tree, the first middleware node 210-1 may generate an ID (P_CBLOCK_ID) of a previous cell block including a previous Merkle tree generated for a previous reference time and a current cell block (C_CBLOCK) including a current Merkle tree (C_MT).

In an embodiment, the ID (P_CBLOCK_ID) of the previous cell block may correspond to a hash value for the previous cell block. In this case, the first middleware node 210-1 may calculate a hash value for the current cell block (C_CBLOCK) and determine the value as a ID (C_CBLOCK_ID) of the current cell block (C_CBLOCK).

Thereafter, the first middleware node 210-1 may perform a third consensus algorithm on the current cell block (C_CBLOCK).

The third consensus algorithm may be performed between the first middleware node 210-1 and the remaining middleware nodes excluding the first middleware node 210-1 among the plurality of middleware nodes 210.

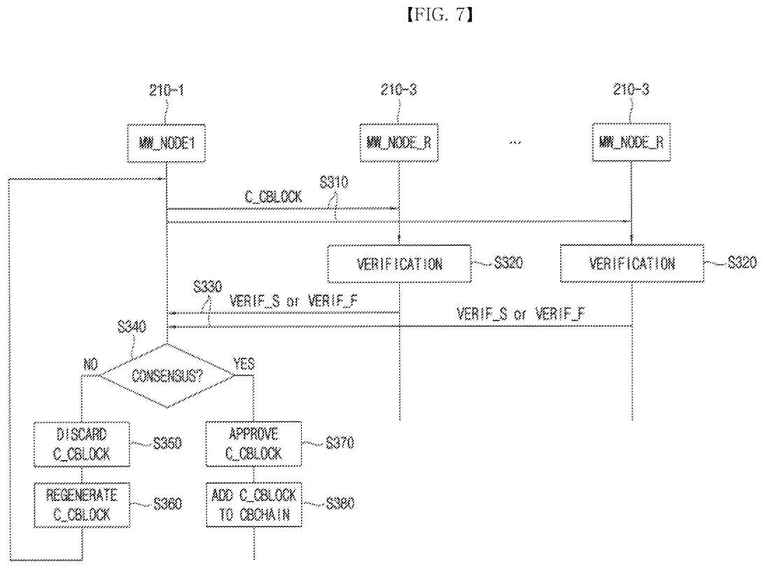

FIG. 7 is a diagram illustrating a process of performing a third consensus algorithm performed in the block chain network of FIG. 1.

Referring to FIG. 7, among a first middleware node (MW_NODE1) 210-1 and a plurality of middleware nodes 210, other middleware nodes excluding the first middleware node 210-1 (MW_NODE_R) 210-3 performs the third consensus algorithm, the first middleware node 210-1 may transmit the current cell block (C_CBLOCK) to the remaining middleware nodes 210-3 (step S310).

If each of the remaining middleware nodes 210-3 receives the current cell block (C_CBLOCK) from the first middleware node 210-1, the validity of the current Merkle tree (C_MT) included in the current cell block (C_CBLOCK) may be verified (step S320).

Each of the remaining middleware nodes 210-3 may calculate hash value for the original transaction data (OTD) included in the unit transaction (UNIT_TX) for each of the unit transactions (UNIT_TX) included in the current Merkle tree (C_MT). according to an embodiment of the present invention.

If the Merkle tree constructed using the calculated hash values and the current Merkle tree (C_MT) match, it is determined that the verification was successful, and the Merkle tree constructed using the calculated hash values and the current Merkle tree (C_MT) match. If not, it can be determined that the verification has failed.

Each of the remaining middleware nodes 210-3 may transmit a verification success signal (VERIF_S) to the first middleware node 210-1 if the verification is successful, and transmit a verification failure signal (VERIF_F) to the first middleware node 210-1 if the verification fails (step S330).

If receiving the verification success signal (VERIF_S) from the number of middleware nodes 210-3 corresponding to a ratio higher than the threshold ratio among the remaining middleware nodes 210-3, the first middleware node 210-1 may determine that the consensus on the current cell block (C_CBLOCK) has been successful (step S340).

In contrast, if receiving a verification success signal (VERIF_S) from the number of middleware nodes 210-3 corresponding to a ratio lower than or equal to the threshold ratio among the remaining middleware nodes 210-3, the first middleware node 210-1 may determine that the agreement on the current cell block (C_CBLOCK) has failed (step S340).

If it is determined that the consensus on the current cell block (C_CBLOCK) has failed (step S340; NO), the first middleware node 210-1 may discard the current cell block (C_CBLOCK) (step S350).

In this case, the first middleware node 210-1 may regenerate the Merkle tree (C_MT) using the hash values (HASH_ODT) for the unit transactions (UNIT_TX) and unit transactions (UNIT_TX) approved through the second consensus algorithm during the reference time.

In addition, the first middleware node 210-1 may regenerate the ID (P_CBLOCK_ID) of the previous cell block including the previous Merkle tree generated for the previous reference time and the current cell block (C_CBLOCK) including the current Merkle tree (C_MT) (step S360).

Thereafter, the first middleware node 210-1 may perform the third consensus algorithm again on the regenerated current cell block (C_CBLOCK).

On the other hand, if it is determined that the consensus on the current cell block (C_CBLOCK) is successful (step S340; YES), the first middleware node 210-1 determines the current cell block (C_CBLOCK) (step S370), and the current cell A block (C_CBLOCK) may be added to the end of a cell block chain (CBCHAIN) in which a plurality of cell blocks are connected in a chain form (step S380).

Therefore, the cell block chain (CBCHAIN) may correspond to a digital provisional ledger that is temporary stored before the original transaction data (OTD) generated from the service providing server 110 is stored in the main block chain 320 of the main net 300.

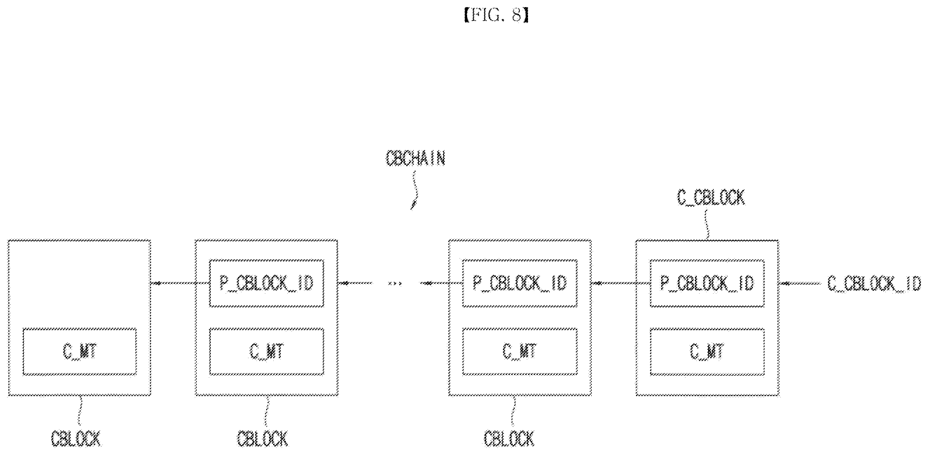

FIG. 8 is a diagram illustrating an example of a cell block chain to which a current cell block has been added.

As shown in FIG. 8, each of the plurality of cell blocks (CBLOCKs) included in the cell block chain (CBCHAIN) may include an ID (P_CBLOCK_ID) of a previous cell block and a current Merkle tree (C_MT).

At this time, since the previous cell block does not exist for the first cell block (CBLOCK) of the cell block chain (CBCHAIN), the first cell block (CBLOCK) may not include the ID of the previous cell block (P_CBLOCK_ID).

Since the ID (P_CBLOCK_ID) of the previous cell block included in the cell block (CBLOCK) refers to the previous cell block (CBLOCK), a plurality of cell blocks (CBLOCK) included in the cell block chain (CBCHAIN) may be connected in a chain form through the ID (P_CBLOCK_ID) of the previous cell block.

If the first middleware node 210-1 determines the current cell block (C_CBLOCK) by successfully consensus on the current cell block (C_CBLOCK) through the third consensus algorithm, as shown in FIG. 8. The current cell block (C_CBLOCK) is additionally connected to the last cell block (CBLOCK) of the chain (CBCHAIN), and the ID (C_CBLOCK_ID) of the current cell block (C_CBLOCK) can be updated with the head of the cell block chain (CBCHAIN).

In an embodiment, if determining the current cell block (C_CBLOCK), the first middleware node 210-1 may store the current cell block (C_CBLOCK) in the WORM storage 211 included therein.

On the other hand, the first middleware node 210-1 may periodically or aperiodically transmit Unit transactions (UNIT_TX), which are not stored in the main blockchain 320 of the main net 300 among unit transactions (UNIT_TX) included in a plurality of cell blocks (CBLOCK) connected to the cell blockchain (CBCHAIN), to at least some of the plurality of main net nodes 310 included in the main net 300.

The first middleware node 210-1 may operate as the main net node 310 of the main net 300 according to an embodiment of the present invention.

In this case, the first middleware node 210-1 may transmit unit transactions (UNIT_TX) that are not stored in the main blockchain 320 of the main net 300 among unit transactions (UNIT_TX) included in a plurality of cell blocks (CBLOCK) connected to the cell blockchain (CBCHAIN) to at least some of the plurality of main net nodes 310 in a broadcasting method.

The plurality of main net nodes 310 may store unit transactions (UNIT_TX) received from the first middleware node 210-1 in the main blockchain 320.

For example, the plurality of main net nodes 310 may generate a block including unit transactions (UNIT_TX) received from the first middleware node 210-1 for a predetermined period of time and generate a plurality of blocks for the generated block. After reaching an agreement between the main net nodes 310, if the consensus is successful, the plurality of main net nodes 310 may store the unit transactions (UNIT_TX) in the main blockchain 320 by adding the generated block to the end of the main blockchain 320.

Meanwhile, if unit transactions (UNIT_TX) transmitted by the first middleware node 210-1 to the plurality of main net nodes 310 are stored in the main blockchain 320, the first middleware node 210-1 may transmit a storage completion signal corresponding to each of the unit transactions (UNIT_TX) that has been stored in the main blockchain 320 to the service providing server 110.

If the service providing server 110 receives a storage completion signal from the first middleware node 210-1, it can be confirmed that the original transaction data (OTD) included in the unit transaction (UNIT_TX) corresponding to the storage completion signal is safely stored in the main blockchain.

The master node 220 may store by periodically backing up data stored in the WORM storage 211 of each of the plurality of middleware nodes 210 according to an embodiment of the present invention.

For example, the master node 220 may periodically back up original transaction data (OTD), unit transactions (UNIT_TX), and cell blockchain (CBCHAIN) stored in the worm storage 211 of each of the plurality of middleware nodes 210.

As described above, the WORM storage 211 may represent a data storage device in which, once data is written, only a read operation is possible for the written data and the written data cannot be modified or deleted.

Therefore, even when a hacking attack occurs on the main net 300 and the main blockchain 320 is damaged, since the original transaction data (OTD), unit transactions (UNIT_TX), and the cell blockchain (CBCHAIN) are safely stored a plurality of middleware nodes 210 and the WORM storage 211 of the master node 220 the security of the blockchain network 10 according to embodiments of the present invention.

As described above with reference to FIGS. 1 to 8, the service providing server 110 included in the legacy system 100 may not include a block chain-related module for performing direct data communication with the main net 300, Original transaction data (OTD) through the middleware system 200 may be stored in the main blockchain 320 of the main net 300 by using the open API for performing data communication with the middleware system 200.

Therefore, the blockchain network 10 may safely store the original transaction data (OTD) generated from the service providing server 110 to the main net 300 in the blockchain 320 without major changes to the service providing server 110 according to embodiments of the present invention.

In addition, the middleware system 200 may verify the validity of the original transaction data (OTD) received from the service providing server 110, if the verification is successful, the approval signal (C_S) is first transmitted to the service providing server 110 before storing the original transaction data (OTD) in the main blockchain 320 of the main net 300.

Thereafter, the middleware system 200 may store the original transaction data (OTD) successfully verified in the cell block chain (CBCHAIN) corresponding to the digital temporary ledger, and store the original transaction data (OTD) stored in the cell block chain (CBCHAIN) to the main blockchain 320 of the main net 300.

Therefore, the service providing server 110 may transmit the original transaction data (OTD) to the middleware system 200, and then without having to wait until the original transaction data (OTD) is stored in the main blockchain 320 of the main net 300, upon receiving the approval signal (C_S) for the original transaction data (OTD) from the middleware system 200, it is determined that the conclusion of the transaction contract corresponding to the original transaction data (OTD) has been approved, the service providing server 110 can proceed the next transaction contract based on the transaction contract conclusion.

Accordingly, the blockchain network may safely store the original transaction data (OTD) generated from the service providing server 110 to the main blockchain 320 of the main net 300 without slowing down a transaction contract execution speed of the service providing server 11010 according to the embodiments of the present invention.

### INDUSTRIAL AVAILABILITY

The present invention can be usefully used to safely store transaction contract data in a blockchain without slowing down the transaction contract execution speed in an existing legacy system.

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

### EXPLANATION OF SYMBOLS

| | | | |
|---|---|---|---|
| 10: | blockchain network | 100: | legacy system |
| 110: | service providing server | 120: | user terminal |
| 200: | middleware system | 210: | middleware node |
| 211: | WORM storage | 220: | master node |
| 300: | main net | 310: | main net node |
| 320: | main blockchain | | |

What is claimed is:

1. A blockchain network, comprising:
a legacy system including a service providing server and a plurality of user terminals connected to the service providing server configured to receive a service;
a middleware system including a plurality of middleware nodes configured to verify the validity of the original transaction data by performing a first agreement algorithm with the service providing server on the original transaction data received from the service providing server, if the verification is successful, generate a unit transaction including the original transaction data, internally perform a second consensus algorithm on the unit transaction to notarize the validity of the original transaction data included in the unit transaction, and the notarization if successful, approve the unit transaction and transmits an approval signal indicating that the original transaction data has been approved to the service providing server;
a middleware system configured to generate a current cell block including the unit transactions approved through the second consensus algorithm for a reference time, perform a third consensus algorithm is internally on the current cell block to determine the current cell block, and add the determined current cell block to an end of a cell block chain to which a plurality of cell blocks are connected; and
a main net including a plurality of main net nodes configured to store the unit transaction received from the middleware system in a main blockchain shared among the plurality of main net nodes.

2. The blockchain network of claim 1, wherein the service providing server includes an open API for performing data communication with the middleware system, and using the open API transmits the original transaction data representing a transaction between a transaction between the plurality of user terminals or transaction between the service providing server and the plurality of user terminals to the middleware system and receives the approval signal from the middleware system.

3. The blockchain network of claim 1, wherein the original transaction data includes a sender wallet address, a receiver wallet address, a transaction amount, and a transaction ID.

4. The blockchain network of claim 1, wherein each of the plurality of middleware nodes includes a write once read many (WORM) storage, and if receiving the original transaction data from the service providing server, the original transaction data is stored in the WORM storage.

5. The blockchain network of claim 1, wherein the service providing server performs the first consensus algorithm,
wherein the performing the first consensus algorithm comprises the service providing service transmits the original transaction data to a first middleware node selected from among the plurality of middleware nodes to verify the validity of the original transaction data together with the first middleware node.

6. The blockchain network of claim 5, wherein the service providing server randomly selects the first middleware node from among the plurality of middleware nodes.

7. The blockchain network of claim 5, wherein the service providing server and the first middleware node which is predetermined among the plurality of middleware nodes performs the first consensus algorithm on the first middleware node the original transaction data.

8. The blockchain network of claim 5, wherein if the service providing server and the first middleware node perform the first consensus algorithm,
wherein the service providing server transmits a first confirmation message including the original transaction data and a hash value for the original transaction data to the first middleware node,
wherein the first middleware node first verifies the validity of the original transaction data included in the first confirmation message by using the hash value included in the first confirmation message in response to the first confirmation message, generates the unit transaction including the original transaction data and the hash value if the first verification is successful, and transmits a second confirmation message including a unit transaction ID indicating the unit transaction to the service providing server,
wherein the service providing server transmits a third confirmation message including the hash value and the unit transaction ID included in the second confirmation message to the first middleware node in response to the second confirmation message,
wherein the first middleware node verifies the validity of the original transaction data is included in the unit transaction corresponding to the unit transaction ID included in the third confirmation message by using the hash value included in the third confirmation message in response to the third confirmation message.

9. The blockchain network of claim 8, wherein the first middleware node stores the unit transaction in a write once read many (WORM) storage included therein if the second verification is successful.

10. The blockchain network of claim 8, wherein the first middleware node, if the first verification fails, transmits a failure signal indicating that the original transaction data has been disapproved to the service providing server and stops execution of the first consensus algorithm,
if the second verification fails, discards the unit transaction and transmits the failure signal to the service providing serve,
If the second verification is successful performs the second consensus algorithm on the unit transaction.

11. The blockchain network of claim 5, wherein the second consensus algorithm is performed between a notarization node selected from among the plurality of middleware nodes and the first middleware node.

12. The blockchain network of claim 11, wherein the service providing server selects the notarization node to perform the second consensus algorithm together with the first middleware node from among the plurality of middleware nodes and notify to the first middleware node.

13. The blockchain network of claim 11, wherein the notarization node to perform the second consensus algorithm together with the first middleware node is selected from among the plurality of middleware nodes by the first middleware node.

14. The blockchain network of claim 11, wherein if the first middleware node and the notarization node perform the second consensus algorithm for the unit transaction,
wherein the first middleware node transmits the unit transaction including the original transaction data and a hash value of the original transaction data to the notarization node, and
wherein the notarization node notarizes the validity of the original transaction data included in the unit transaction using the hash value included in the unit transaction, and transmits a notarization success signal to the first middleware node if the notarization is successful, and transmits a notarization failure signal to the first middleware node if the verification fails.

15. The blockchain network of claim 14, wherein the notary node stores the unit transaction received from the first middleware node in a write once read many (WORM) storage included therein if the notarization is successful.

16. The blockchain network of claim 14, wherein, if the first middleware node receives the notarization success signal from the notarization node, the first middleware node approves the unit transaction and transmits an approval signal to the service providing server.

17. The blockchain network of claim 14, wherein if the first middleware node receives the notarization failure signal from the notary node, the first middleware node discards the unit transaction and transmits a failure signal indicating that the original transaction data has been disapproved to the service providing server.

18. The blockchain network of claim 5, wherein the first middleware node generates a current Merkle tree periodically at each reference time using the unit transactions and hash values of the unit transactions approved through the second consensus algorithm, and generates an ID of a previous cell block including a previous Merkle tree generated for a previous reference time and the current cell block including the current Merkle tree.

19. The blockchain network of claim 18, wherein the third consensus algorithm is performed between the first middleware node and other middleware nodes other than the first middleware node among the plurality of middleware nodes,
wherein the first middleware node transmits the current cell block to the remaining middleware nodes if the first middleware node and the remaining middleware nodes perform the third consensus algorithm,
each of the remaining middleware nodes verifies the validity of the current Merkle tree included in the current cell block and transmits one of a verification successes signals and a verification failure signal to the first middleware node,
wherein the first middleware node determines the current cell block, connects the determined current cell block to the last cell block of the cell block chain, and updates the ID of the current cell block to the head of the cell block chain if the first middleware node receives the verification success signal from a number of middleware nodes corresponding to a ratio higher than a threshold ratio among the remaining middleware nodes,

20. The blockchain network of claim 19, wherein if the first middleware node determines the current cell block, the current cell block is stored in a write once read many (WORM) storage included therein.

21. The blockchain network of claim 19, wherein the first middleware node transmits unit transactions not stored in the main blockchain among the unit transactions included in the plurality of cell blocks connected to the cell blockchain to the main net,
wherein the main net stores the unit transactions received from the first middleware node in the main blockchain, and
wherein the first middleware node transmits a storage completion signal corresponding to each of the unit transactions stored in the main blockchain to the service providing server.

22. The blockchain network of claim 1, wherein if the service providing server receives the approval signal for the original transaction data from the middleware system, determines that the execution of a transaction contract corresponding to the original transaction data has been approved, and proceeds a next transaction contract based on the determination the execution of a transaction contract.

23. The blockchain network of claim 1, further comprising:
a master node the middleware system permits a new node to participate in the middleware system as the middleware node, manages a list of the plurality of middleware nodes, monitors operation states of the plurality of middleware nodes, and provide addresses of the plurality of middleware nodes to the service providing server, and periodically backups the original transaction data stored in a write once read many (WORM) storage included in each of the plurality of middleware nodes.

24. The blockchain network of claim 1, wherein the main net corresponds to a public main net in which any node can participate as the main net node.

25. The blockchain network of claim 1, wherein the main net corresponds to a private main net in which only authorized nodes can participate as the main net node.

26. The blockchain network of claim 25, wherein the main net corresponds to a private main net operated by an operator of the service providing server.

27. A method for providing a service for a blockchain network with a legacy system, a middleware system, and a main net, the method comprising:
receiving, by a service providing server and the legacy system including a plurality of user terminals, which receive the service by connecting to the service providing server, the service;
performing, by the service providing server and the middleware system including a plurality of middleware nodes, a first consensus algorithm for an original transaction data received from the service providing server to validate an original transaction data, generating a unit transaction containing the original transaction data if the verification is successful, performing a second consensus algorithm internally for the unit transaction to notarize a validity of the original transaction data included in the unit transaction, approving the unit transaction and transmitting an approval signal indicating that the original transaction data is approved to the service providing server if successful in the notary, generating the current cell block comprising the unit transactions approved through the second consensus algorithm for a predetermined time, confirming the current cell block by performing a third consensus algorithm internally for the current cell block, and adding the confirmed current cell block to an end of the cell blockchain in which a plurality of cell blocks are connected; and
storing, by the main net including a plurality of main net nodes, the unit transaction received from the middleware system in the main blockchain shared between the plurality of main net nodes.
